(19) United States
(12) Patent Application Publication
(10) Pub. No.: US 2004/0240004 A1
(43) Pub. Date: Dec. 2, 2004

(54) Image sensor module

(76) Inventor: Chen Wen Ching, Taichung (TW)

Correspondence Address: CHEN WEN-CHING, P.O. BOX 2103, Taichung, TW

(21) Appl. No.: 10/448,274

(22) Filed: May 30, 2003

(51) Int. Cl. H04N 1/46

(52) U.S. Cl. 358/513

(57) ABSTRACT

An image sensor module includes a printed circuit board (PCB) having a window defined therein and extending through the PCB. The inner periphery of the window is coated with a shelter. The PCB includes multiple leads formed thereon around the window and each lead divided into an inner lead and an outer lead. An image sensing chip is electrically connected to the PCB and includes multiple solder pad formed thereon. Each solder pad aligns with and electrically connected to a corresponding one of the inner leads. A lens set is mounted on the PCB and includes a holder surrounded the window and corresponding to a sensing area of the image sensing chip, wherein the peripheries between the holder, the PCB and the image sensing chip are underfilled with stabilizer to form an airtight condition between the holder, the PCB and the image sensing chip.

### BACKGROUND OF THE INVENTION

1. Field of the Invention

The present invention relates to an image sensor module, and more particularly to an image sensor module that uses an opening in the printed circuit board (PCB) as an assembling board for flipping chip and assembling the lens set to simplify the assembling processes and reduce the volume of the image sensor module.

2. Description of Related Art

With reference to FIGS. 22-24, an integrated circuit (IC) assembly of a conventional image sensor module usually uses the technologies of the ceramic leaded chip carrier (CLCC), plastic leaded chip carrier (PLCC) or the kingpak lead carrier chip (KLCC). The common characteristics of the above technologies comprise the processes of die pad and wire bonding. However, the manufacturing cost and the volume of the image sensor is limited more and more stricter with the suing scope and the habitude of the consumers. Consequently, the conventional image sensor module has several disadvantages as follow.

1. The CLCC need the technology of sintering such that the image sensor cannot be mass-produced and has a high manufacturing cost. Consequently, the CLCC only used to a product that is required a high power or needs a good reliability.

2. As shown in FIGS. 22 and 24, the PLCC needs to pre-mold a sidewall (90a) and the baseboard (90b) of the KLCC needs to be formed with the lead frame (not numbered). Consequently, the above two technologies need to prepare a mold and have complicated manufacturing processes. The manufacturing costs of the above two technologies are only lower than that of the CLCC. However, the assembled object of the two technologies has a bad heat-dissipate effect such that the grain of the image sensor maybe warp or moist and has a bad reliability.

3. With reference to FIG. 23, the baseboard of the PLCC comprises a first PCB (90) having one face with circuits and a second PCB being glued together on the face of the first PCB. The manufacturing processes do not unlikely be simplified and the second PCB may be detached from the first PCB due to a failing glue process.

4. The technology of the PLCC comprises an extra process for forming lead frame that can be mass-produced. However, the reliability of wire bonding relates to the precision of the lead frame such that the PLCC almost cannot be usable to a assembled of a chip of a high frequency I/O.

5. All the above technologies need a process of wire bonding that needs equipment and the manufacturing effect is hard to be increased. With reference to FIG. 25, the total thickness is great when the conventional image sensor module used in an image collect module. Consequently, the conventional image sensor module cannot not be used in a portable electric product, such as a cell phone, a PDA (personal digital assistant), a PC camera and the like.

Nowadays, the technology of assembling an IC is directed to an assembling method of flip chip. This technology needs to grow bumps on a wafer and the bumps are electrically connected to the circuit on a baseboard such that a top side of the chip must face the baseboard and a prerequisite condition of an open sensing area of an image sensor is limited. Consequently, the flip chip has a best electric quality, a good heat-dissipation and a small volume. However, the technology cannot be used in an image sensor.

The present invention has arisen to mitigate and/or obviate the disadvantages of the technology of the conventional image sensor.

### SUMMARY OF THE INVENTION

The main objective of the present invention is to provide an improved image sensor module that can promote and ensure the reliability of the image sensor module, and has a small volume suiting the requirement of the market.

To achieve the objective, the image sensor module in accordance with the present invention comprises a printed circuit board (PCB) having a window defined therein and extending through the PCB. The inner periphery of the window is coated with a shelter. The PCB includes multiple leads formed thereon around the window and each lead divided into an inner lead and an outer lead. An image sensing chip is electrically connected to the PCB and includes multiple solder pad formed thereon. Each solder pad aligns with and electrically connected to a corresponding one of the inner leads. A lens set is mounted on the PCB and includes a holder surrounded the window and corresponding to a sensing area of the image sensing chip, wherein the peripheries between the holder, the PCB and the image sensing chip are underfilled with stabilizer to form an airtight condition between the holder, the PCB and the image sensing chip.

Further benefits and advantages of the present invention will become apparent after a careful reading of the detailed description with appropriate reference to the accompanying drawings.

### BRIEF DESCRIPTION OF THE DRAWINGS

FIG. 1 is a side cross-sectional view of a first embodiment of an image sensor module in accordance with the present invention;

FIG. 2A is a plan view of a PCB of the image sensor module in FIG. 1;

FIG. 2B is a plan view of the PCB in FIG. 2A;

FIG. 3A is a plan view of the PCB in FIG. 2A that multiple leads are formed on the PCB;

FIG. 3B is a plan view of the PCB in FIG. 3A;

FIG. 4A is a plan view of the PCB in FIG. 3A that multiple solder points are formed on the PCB;

FIG. 4B is a plan view of the PCB in FIG. 4A;

FIG. 5A is a plan view that shows a chip is attached to a top surface of the PCB in FIG. 4A;

FIG. 5B is a plan view that shows a chip is attached to a top surface of the PCB in FIG. 4B;

FIG. 6 is a side cross-sectional view of a second embodiment of an image sensor module in accordance with the present invention;

FIG. 6A is a top plan view of the surface mount technology (SMT) baseboard in FIG. 6;

FIG. 7 is a side cross-sectional view of a third embodiment of an image sensor module in accordance with the present invention;

FIG. 8 is a side cross-sectional view of a fourth embodiment of an image sensor module in accordance with the present invention;

FIG. 9 a side cross-sectional view of a fifth embodiment of an image sensor module in accordance with the present invention;

FIG. 10 a side cross-sectional view of a sixth embodiment of an image sensor module in accordance with the present invention;

FIG. 11 a side cross-sectional view of a seventh embodiment of an image sensor module in accordance with the present invention;

FIG. 12 a side cross-sectional view of an eighth embodiment of an image sensor module in accordance with the present invention;

FIG. 13 a side cross-sectional view of a ninth embodiment of an image sensor module in accordance with the present invention;

FIG. 14 a side cross-sectional view of a tenth embodiment of an image sensor module in accordance with the present invention;

FIG. 15 a side cross-sectional view of an eleventh embodiment of an image sensor module in accordance with the present invention;

FIG. 16 a side cross-sectional view of a twelfth embodiment of an image sensor module in accordance with the present invention;

FIG. 17 a side cross-sectional view of a thirteenth embodiment of an image sensor module in accordance with the present invention;

FIG. 18 a side cross-sectional view of a fourteenth embodiment of an image sensor module in accordance with the present invention;

FIG. 19 a side cross-sectional view of a fifteenth embodiment of an image sensor module in accordance with the present invention;

FIG. 20 a side cross-sectional view of a sixteenth embodiment of an image sensor module in accordance with the present invention;

FIG. 21 a side cross-sectional view of a seventeenth embodiment of an image sensor module in accordance with the present invention;

FIG. 22 is a side cross-sectional view of a conventional PLCC image sensor in accordance with the prior art;

FIG. 23 is a side cross-sectional view of another conventional PLCC image sensor in accordance with the prior art;

FIG. 24 is a side cross-sectional view of a conventional KLCC image sensor in accordance with the prior art; and

FIG. 25 is a side cross-sectional view of a conventional image sensor module in accordance with the prior art.

### DETAILED DESCRIPTION OF THE INVENTION

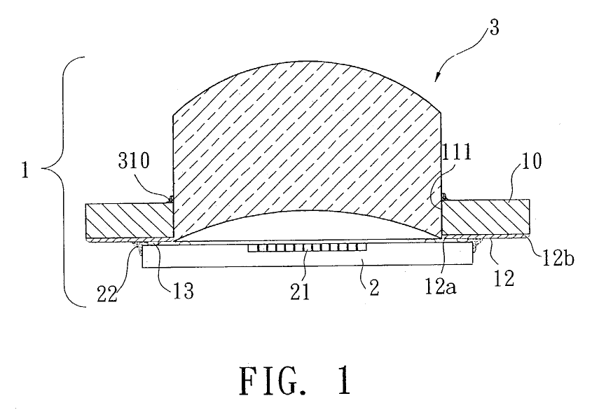

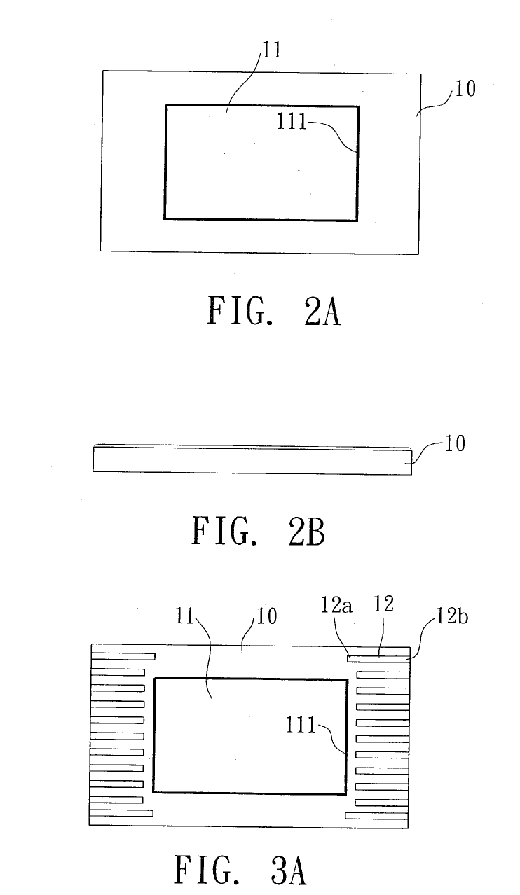

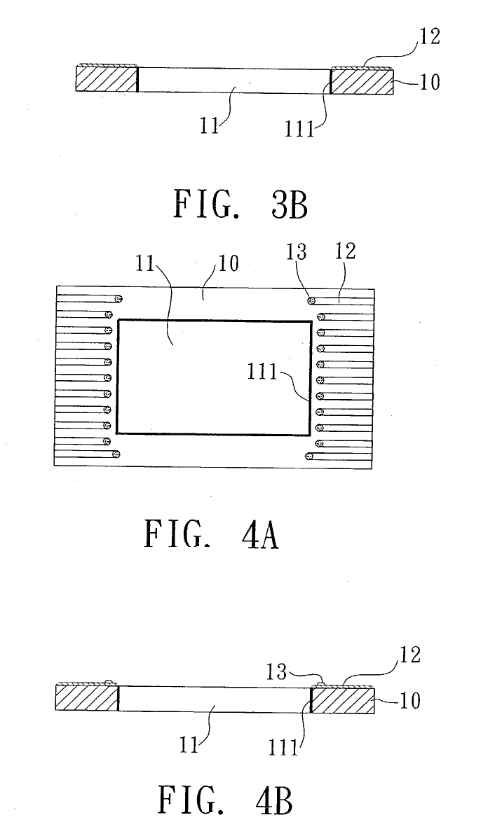

Referring to the drawings and initially to FIGS. 1-3B, an image sensor module (1) in accordance with the present invention comprises a printed circuit board (PCB) (10) including an opening (11) defined therein. An image sensing chip (2) is attached to one side of the PCB (10) and linearly corresponds to the opening (11) for closing the opening (11). A shelter (111) is coated on an inner periphery of the opening (11) to prevent the dust from flowing onto the periphery of the image sensing chip (2). The shelter (111) is a solder mask or a golden electroplating.

The PCB (10) has a first side facing the image sensing chip (2) and having multiple leads (12) formed on the first side of the PCB (10) by etching. The leads (21) formed and correspond to two opposite sides of the opening (11) in the PCB (10). Each lead (12) is divided into an inner lead (12a) toward the opening (11) and an outer lead (12b) opposite to the inner lead (12a). A solder mask is coated between every two adjacent leads (12). Further with reference to FIGS. 4A and 4B, each inner lead (12a) forms a solder point (13) thereon and the solder point (13) is coated with medium that electric conducting and adhesive material, such as silver gel, tin grease or the like. The embodiment of the present invention is used when the image sensing chip has a very small volume.

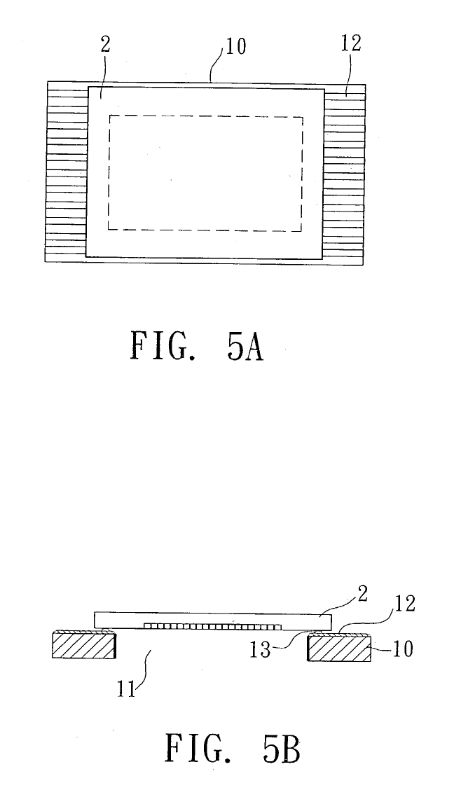

With reference to FIGS. 5A and 5B, the image sensing chip (2) includes multiple solder pads (not shown) each electrically connected to a corresponding one of the solder point (13) by flip chip or no-wire bonding method.

With reference to FIG. 1, the present invention is adapted to be connected to a lens (3) that corresponds to an image sensing area (21) in the image sensing chip (2). The peripheries between the PCB (10), the lens (3) and the image sensing chip (2) are underfilled with ultraviolet (UV) stabilizer (310, 22) that will be hardened after being shined by UV rays to airtightly close the peripheries between the PCB (10), the lens (3) and the image sensing chip (2).

As described above, the image sensor module (1) in accordance with the present invention uses the PCB (10) to replace the PLCC and the KLCC, and uses the leads formed by etching to replace the conventional lead frame. Consequently, the quality of assembling of the present invention is the same as that of flip chip and has a good electric quality, a good heat-dissipation and a small volume. Furthermore, the present invention can use the SMT to electrically mount the image sensing chip (2) on the PCB (10) such that the present invention can be pass-produced by using a bonder machine or a SMT device to reduce the manufacturing cost and ensure the reliability of the image sensor module. Consequently, the present invention has greatly reduced the thickness of the image sensor module for the downstream products.

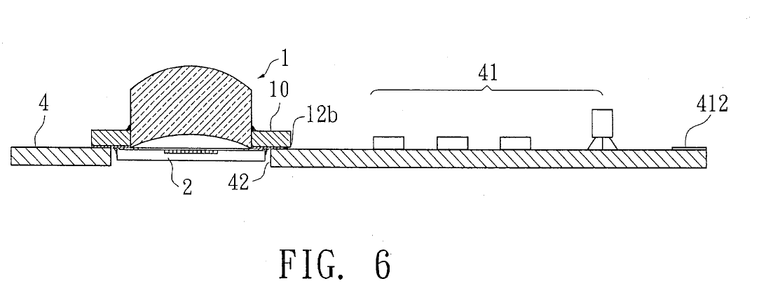

With reference to FIG. 6 that shows a second embodiment of an image sensor module (1) in accordance with the present invention. The image sensor module (1) is adapted to be electrically mounted to a SMT board (4) by using the outer leads (12b) of the PCB (10). The SMT board (4) includes a module circuit (41) formed thereon and an opening (42) defined therein. The image sensing chip (2) is situated within the opening (42) in the SMT board (4) when the image sensor module (1) is electrically mounted on the SMT board (4). The SMT board (4) includes multiple leads (411) formed around the opening (42) in the SMT board (4) and each provided to be electrically connected to a corresponding one of the outer leads (12b), and multiple connecting leads (412) formed on one side of the SMT board (4) for connected to an suitable electric device. The embodiment can effectively control the thickness of the SMT board (4).

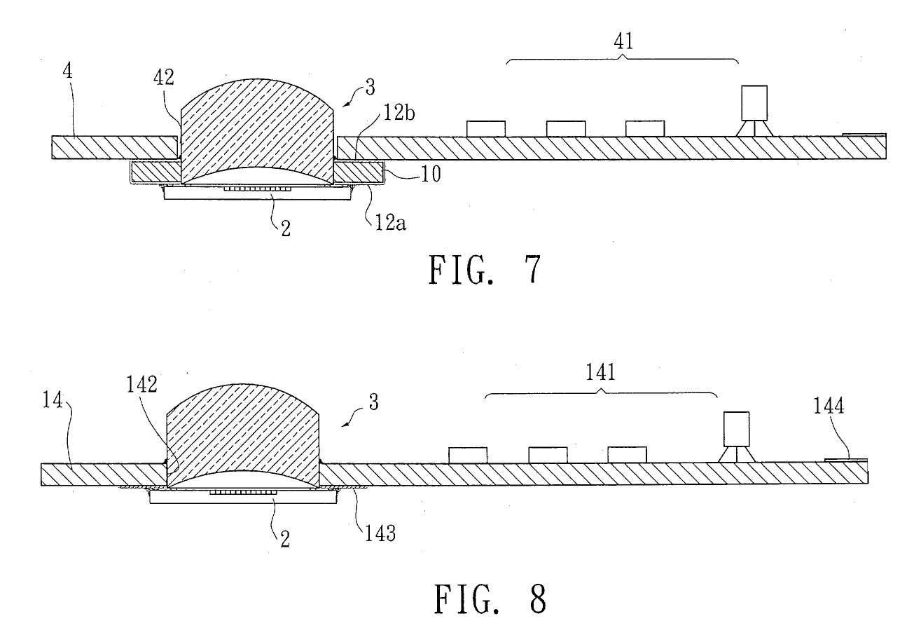

With reference to FIG. 7 that shows a third embodiment of an image sensor module in accordance with the present invention. The inner leads (12a) is formed on a lower side of the PCB (10) for electrically connected to the image sensing chip (2) and the outer leads (12b) is formed on an upper side of the PCB (10) for electrically connected to the SMT board (4) after the image sensor module (3) extending through the opening (42) in the SMT board (4).

With reference to FIG. 8 that shows a fourth embodiment of an image sensor module in accordance with the present invention. The PCB (14) includes a module circuit (141) formed on an upper side of the PCB (14), a window (142) defined in and extending through the PCB (14), multiple leads (143) formed on a lower side of the PCB (14) by etching surrounding the window (142) and multiple leads (144) is formed on one side of the PCB (14). As the structure of the PCB (14), the image sensing chip (2) and the lens (3) with the PCB (14) can be assembled to a one-piece module by a bonder machine of a SMT device such that the SMT board is unnecessary to the embodiment and the thickness of the image sensor module is reduced.

With reference to FIG. 9 that shows a fifth embodiment of an image sensor module (5) in accordance with the present invention. The PCB (50) includes a window (51) defined in and extending through the PCB (50). The size of the window (51) corresponds to that of the image sensing chip (2). The windows (51) has an inner periphery that is coated with a shelter (511) to prevent the dust from flowing onto the periphery of the image sensing chip (2).

The PCB (50) includes multiple leads (52) formed on a lower side thereof around the window (51). Each lead (52) is divided into an inner lead (52a) toward the window (51) and an outer lead (52b) opposite to the inner lead (52a). A solder mask is coated on the PCB (50) between every two adjacent leads (52) and each lead (52) is partially coated with medium that electric conducting and adhesive material to form a solder point (53) on each of the leads (52). The image sensing chip (2) is mounted to the lower side of the PCB (50) and electrically connected to the inner leads (52a) of each of the leads (52). A lens set (3a) with a holder (31a) attached to an upper side of the PCB (50) surrounding the window (51) in the PCB (50). The peripheries between the holder (31a), the PCB (50) and the image sensing chip (2) is underfilled with UV stabilizer to formed a airtight condition between the holder (31a), the PCB (50) and the image sensing chip (2) after the UV stabilizer being shined under UV rays and hardened.

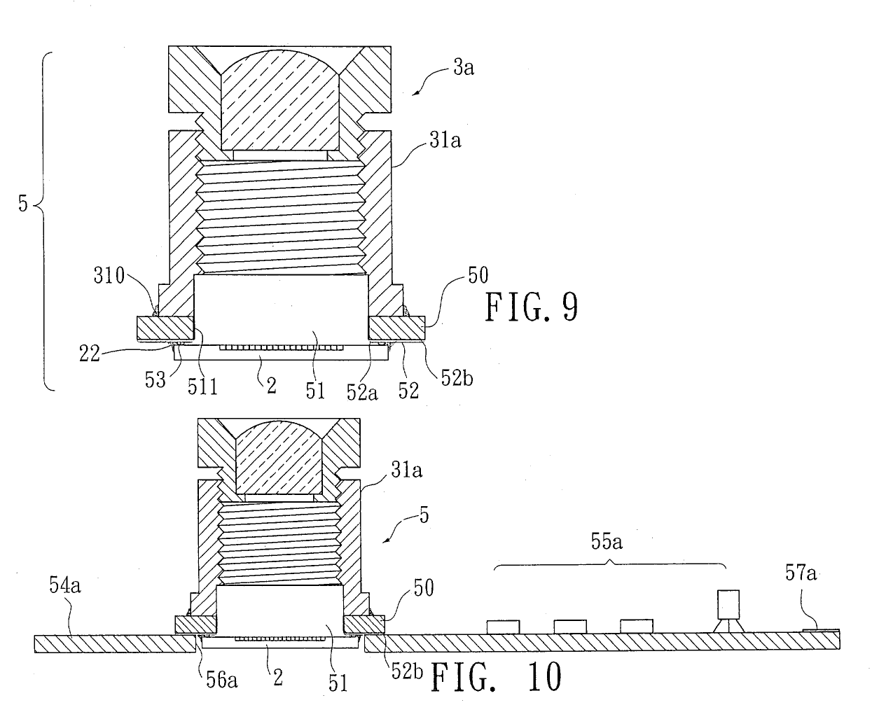

With reference to FIG. 10 that shows a sixth embodiment of an image sensor module in accordance with the present invention. The image sensor module (50), as shown in FIG. 9, is adapted to be attached to a SMT board (54a). The SMT board (54s) includes a module circuit (55a) formed thereon, an opening (56a) defined therein and multiple leads (not shown) formed around the opening (56a) in the SMT board (54a). The image sensing chip (2) is located within the opening (56a) in the SMT board (54a) and the outer leads (52b) each electrically connected to a corresponding one of the leads of the SMT board (54a). The SMT board (54a) further includes multiple connecting leads (57a) formed on one side of the SMT board (54a) for electrically connecting to a suitable electric device.

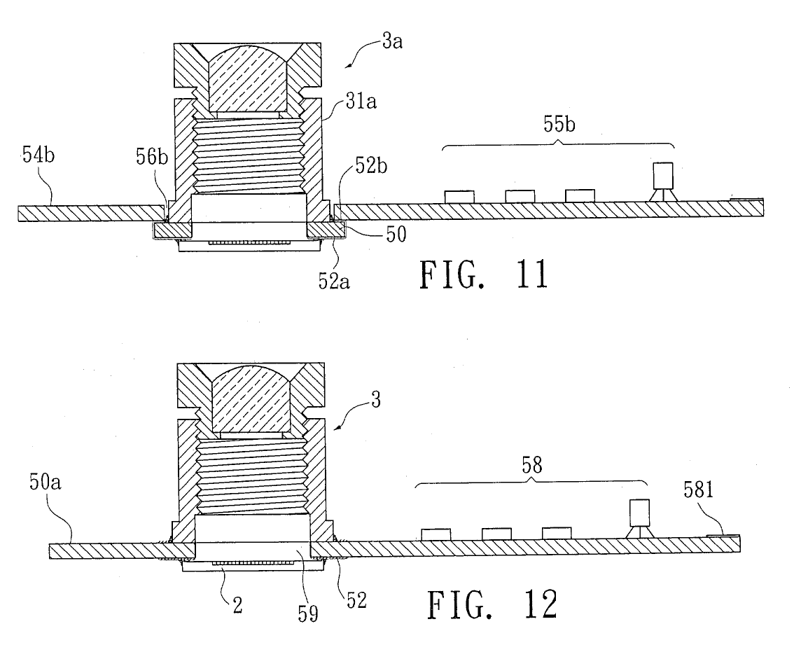

With reference to FIG. 11 that shows a seventh embodiment of an image sensor module in accordance with the present invention. The inner leads (52a) are formed on a lower side of the PCB (50) and the outer leads (52b) are formed on an upper side of the PCB (50). Each inner lead (52a) is electrically connected to a corresponding one of the outer leads (52b). The outer leads (52b) are electrically connected to a lower side of the SMT board (54b). The SMT board (54b) includes an opening (56b) defined therein and allowing the lens set (3a) extending through the SMT board (54b).

With reference to FIG. 12 that shows an eight embodiment of an image sensor module in accordance with the present invention. The PCB (50a) includes a module circuit (58) formed thereon and a window (59) defined therein and extending through the PCB (50a). Multiple leads (52) are formed on a lower side of the PCB (50a) and multiple connecting leads (581) are formed on one side of the PCB (50a). Consequently, the image sensing chip (2), the lens set (3) can be assembled into a one-piece module by using the bonder machine or a SMT device.

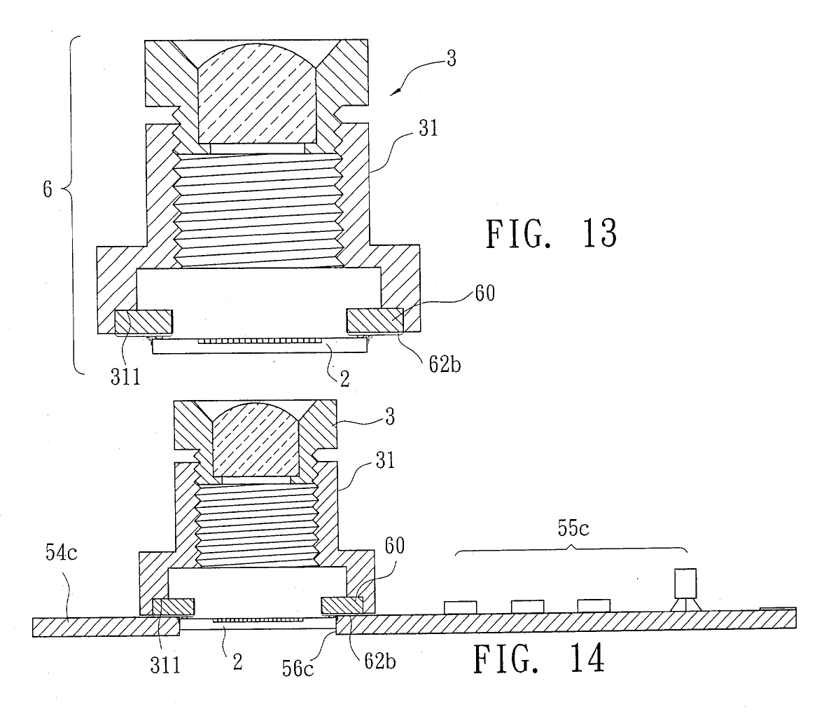

With reference to FIG. 13 that shows a ninth embodiment of an image sensor module (6) in accordance with the present invention. The holder (31) includes a recess (311) defined in a bottom of the holder (31) for receiving the PCB (60) for a more precise lens set (3).

With reference to FIG. 14 that shows a tenth embodiment of an image sensor module (6) in accordance with the present invention. The outer leads (62b) are electrically connected to a SMT board (54c) by SMT. The SMT board (54c) includes a module circuit (55c) electrically connected to the PCB (60) and an opening (56c) defined in the SMT board (54c). The image sensing chip (2) is located within the opening (56c) when the lens set (3) attached to the upper side of the SMT board (54c).

With reference to FIG. 15 that shows an eleventh embodiment of an image sensor module (7) in accordance with the present invention. The PCB (70) includes a window (71) defined therein and extending through the PCB (70). The holder (31) of the lens set (3) is partially inserted into the window (71) in the PCB (70) and has an annular groove (312) for receiving an inner periphery of the window (71) in the PCB (70) to promote the precision of the lens set (3).

With reference to FIG. 16 that shows a twelfth embodiment of an image sensor module (7) in accordance with the present invention. The outer leads (72) are electrically connected to the SMT board (54d) by SMT. The SMT board (54d) includes a module circuit (55d) electrically connected to the PCB (70) and an opening (56d) defined therein. The image sensing chip (2) is located within the opening (56d) in the SMT board (54d) when the PCB (70) attached to the upper side of the SMT board (54d).

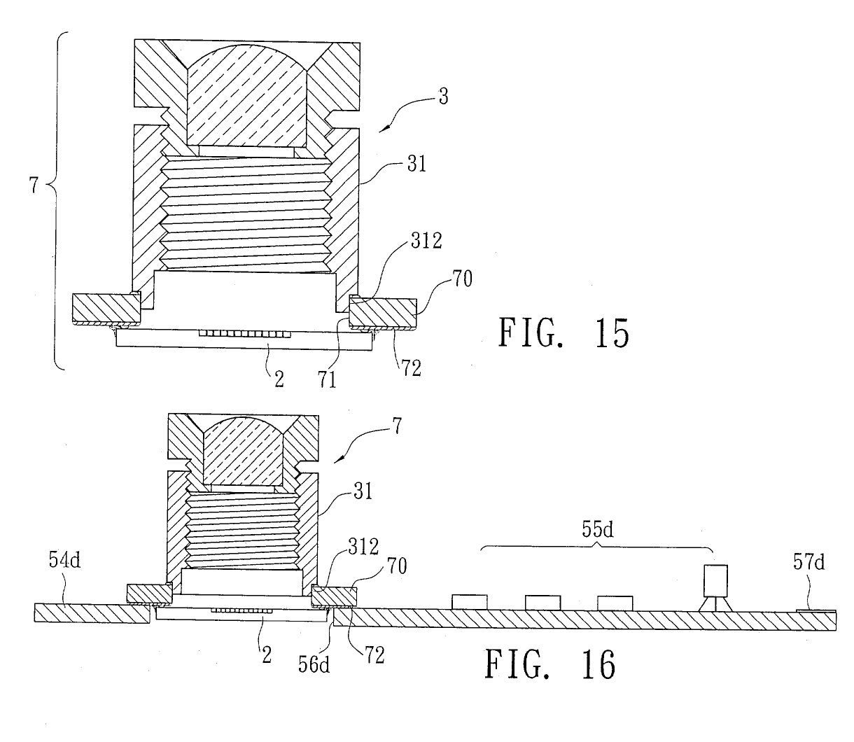

With reference to FIG. 17 that shows a thirteenth embodiment of an image sensor module in accordance with the present invention. The PCB (70) includes multiple inner leads (72a) formed on a lower side of the PCB (70) and multiple outer leads (72b) formed on an upper side of the PCB (70). Each inner lead (72a) is electrically connected to a corresponding one of the outer leads (72b). The PCB (70) is electrically connected to the lower side of the SMT board (54e) that includes an opening (56e) defined therein. The lens set (3) extends through the opening (56e) when the PCB (70) is connected to the SMT board (54e).

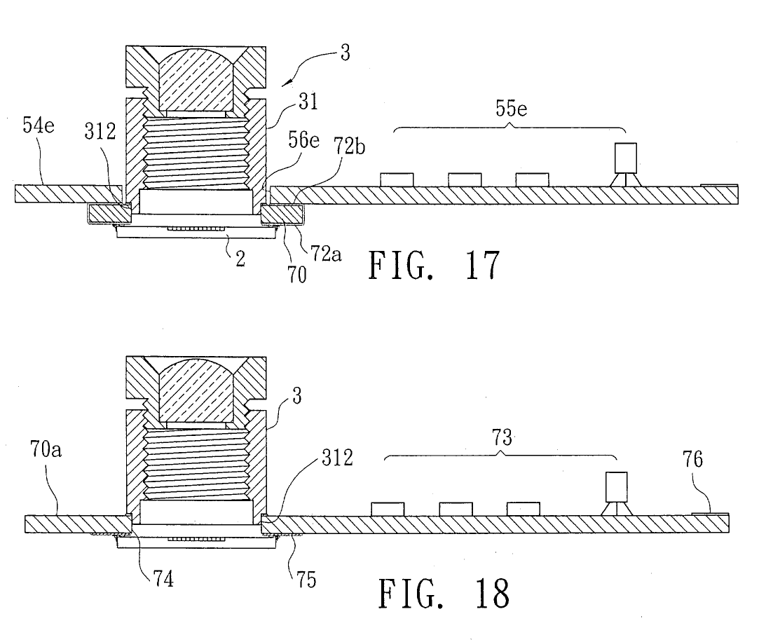

With reference to FIG. 18 that shows a fourteenth embodiment of an image sensor module in accordance with the present invention. The PCB (70a) includes a module circuit (73) formed thereon and multiple connecting leads (76) formed on one side of the PCB (70a). The PCB (70a) includes a window (74) defined therein and extending through the PCB (70a). The PCB (70a) includes multiple leads (75) formed on a lower side of the PCB (70a) around the window (74). The bottom of the lens set (3) has an annular groove (312) defined to partially receive an inner periphery of the window (74). Consequently, the image sensing chip (2) and the lens set (3) can be assembled to a one-piece module by bonder machine or a SMT device.

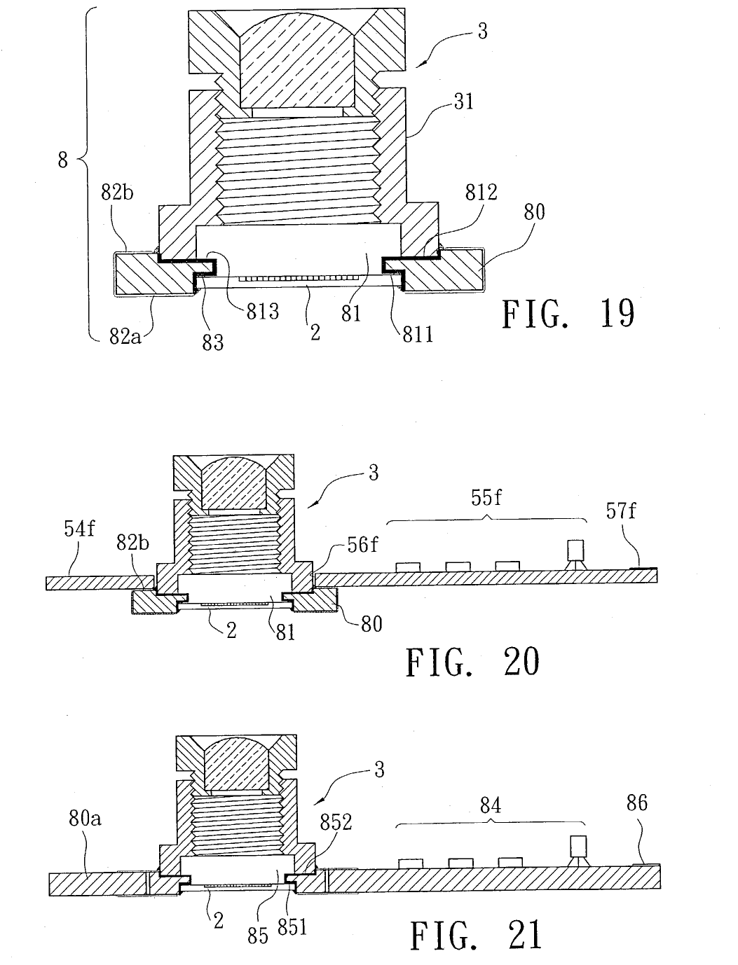

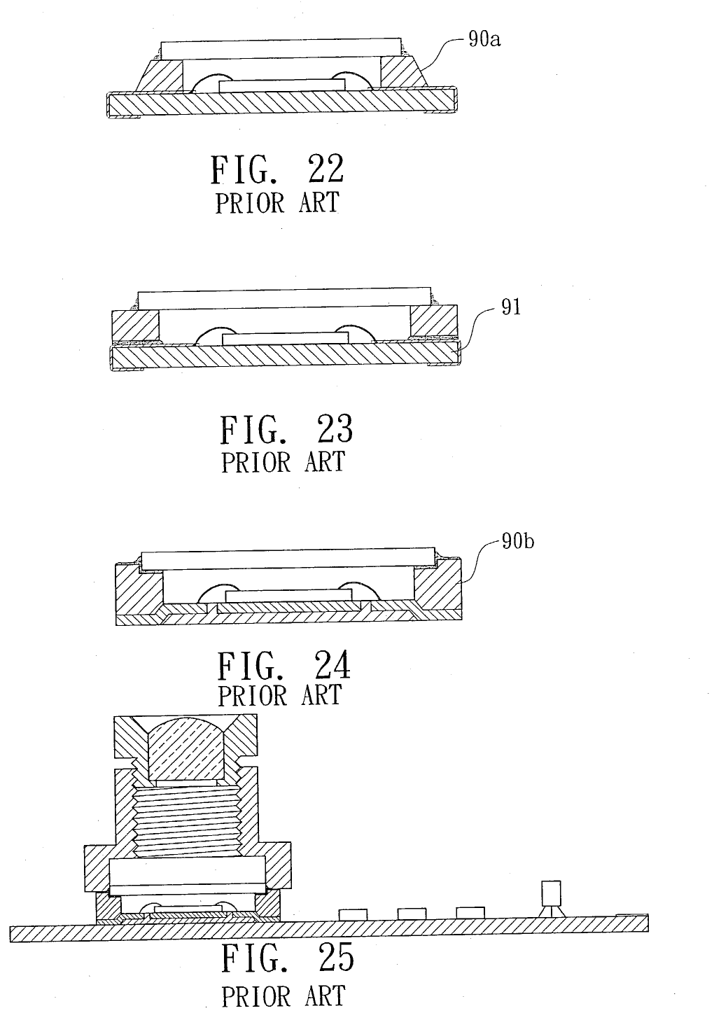

With reference to FIG. 19 that shows a fifth embodiment of an image sensor module (8) in accordance with the present invention. The PCB (80) includes a window (81) defined therein and extending through the PCB (80), a first recess (811) defined in a lower side of the PCB (80) and communicating with the window (81) in the PCB (80), and a second recess (812) defined in a upper side of the PCB (80) and communicating with the window (81) in the PCB (80). The window (81), the first recess (811) and the second recess (812) each has an inner periphery that is coated with a shelter (813) to prevent the dust from flowing onto the image sensing chip (2).

The PCB (80) includes multiple inner leads (82a) formed on a lower side of the PCB (80) and multiple outer leads (82b) formed on an upper side of the PCB (80). Each inner lead (82a) electrically is connected to a corresponding one of the outer leads (82b). Each inner lead (82a) and each outer lead (82b) are partially coated with medium that electric conducting and adhesive material to form a solder point (83) on each of the inner lead (82a) and each outer leads (82b).

The image sensing chip (2) is securely received in the first recess (811) and electrically connected to the solder points (83) on the PCB (80). The holder (31) of the lens set (3) is partially and longitudinally received in the second recess (812). The peripheries between the PCB (80), the holder (31) and the image sensing chip (2) are underfilled with ultraviolet UV stabilizer that will be hardened after being shined by UV rays to airtightly close the peripheries between the PCB (80), the holder (31) and the image sensing chip (2). The type of the embodiment is used to reduce the volume of the assembled module when the image sensing chip (2) is very small.

With reference to FIG. 20 that shows a sixteenth embodiment of an image sensor module in accordance with the present invention. The outer leads (82b) are electrically connected to a lower side of the SMT board (54f). The SMT board (54f) includes a module circuit (55f) formed thereon, multiple connecting leads (57f) formed on one side of the SMT board (54f) to be connected to a suitable electric device and an opening (56f) defined in the SMT board (54f). The lens set (3) extends through the opening (56f) when the PCB (80) connected to the SMT board (54f).

With reference to FIG. 21 that shows a seventeenth embodiment of an image sensor module in accordance with the present invention. The PCB (80a) includes a module circuit (84) formed thereon, multiple connecting leads (86) formed on one side of the PCB (80a) and a window (85) defined in and extending through the PCB (80a). A first recess (851) is defined in a lower side of the PCB (80a) and communicates with the window (85) in the PCB (80a), and a second recess (852) is defined in a upper side of the PCB (80a) and communicates with the window (85) in the PCB (80a). The lens set (3) is longitudinally mounted to the upper side of the PCB (80a) and partially received in the second recess (852). The image sensing chip (2) is received in the first recess (851) and electrically connected to the PCB (80a). The embodiment of the present invention can effectively reduce the volume of the image sensor module.

As described above, the image sensor module in accordance with present invention includes the following advantages.

1. The SMT can be used in the manufacturing the image sensor module in accordance with the present invention such that the present invention can be automatically mass-produced.

2. The improved manufacturing process of the present invention can promote and ensure the reliability of the image sensor module in accordance with the present invention.

3. A glass is unnecessary to the present invention. Furthermore, some embodiments of the present invention needn't an extra Circuit board. Consequently, the manufacturing cost has been reduced.

4. The lens set can be directly used in an assembling process such that the manufacturing effect has been promoted.

5. The volume of the image sensor module in accordance with the present invention has been reduced such that the using scope of the present invention is wide.

6. The selling price is reduced due to a promoted manufacturing effect and a reduced manufacturing cost.

Although the invention has been explained in relation to its preferred embodiment, it is to be understood that many other possible modifications and variations can be made without departing from the spirit and scope of the invention as hereinafter claimed.

What is claimed is:

1. An image sensor module comprising:
a printed circuit board (PCB) including a window defined therein and extending through the PCB, the window having an inner periphery that is coated with a shelter, the PCB including multiple leads formed thereon around the window by etching, each lead divided into an inner lead and an outer lead;
an image sensing chip electrically connected to the PCB, the image sensing chip including multiple solder pad formed thereon, each solder pad aligning with and electrically connected to a corresponding one of the inner leads on the PCB; and
a lens mounted on the PCB and corresponding to a sensing area of the image sensing chip, wherein the peripheries between the lens, the PCB and the image sensing chip are underfilled with stabilizer to form an airtight condition between the holder, the PCB and the image sensing chip.

2. The image sensor module as claimed in claim 1, wherein all the leads are formed on one side of the PCB.

3. The image sensor module as claimed in claim 2, wherein the PCB comprises a module circuit formed thereon and electrically connected to the image sensing chip, and multiple connecting leads electrically connected to the module circuit and adapted to be connected to a suitable electric device.

4. The image sensor module as claimed in claim 2, wherein the outer leads of the PCB are electrically connected to a SMT board, the SMT board including a module circuit formed thereon, an opening defined therein and multiple connecting leads formed one side of the SMT board, the SMT board including multiple leads formed thereon around the opening and electrically connected to the PCB when the lens set secured on the SMT board and extends through the window.

5. The image sensor module as claimed in claim 1, wherein the inner leads are formed on a first side of the PCB and the outer leads are formed of the a second side of the PCB, each inner lead electrically connected to a corresponding one of the outer leads.

6. The image sensor module as claimed in claim 5, wherein the PCB comprises a module circuit formed thereon and multiple connecting lead formed on one side of the PCB.

7. The image sensor module as claimed in claim 5, wherein the outer leads are electrically connected to the SMT board by SMT, the SMT board including a module circuit formed thereon, an opening defined therein and multiple connecting leads formed on one side of the SMT board, the SMT board including multiple leads formed around the opening for electrically connected to the PCB when the lens secured on the SMT board and extends through the opening in the SMT board.

8. An image sensor module comprising:
a PCB including a window defined therein and extending therethrough, the window having an inner periphery coated with a shelter, the PCB including multiple leads formed thereon by etching and around the window, each lead divided into an inner lead toward the window and an outer lead opposite to the inner lead;
an image sensing chip electrically mounted to the PCB, the image sensing chip including multiple solder pads formed thereon, each solder pad electrically connected to a corresponding one of the inner leads when the image sensing chip is mounted to the PCB; and
a lens set mounted to the PCB, the lens set including a holder secured on the PCB and closing the window in the PCB, wherein the peripheries between the PCB, the holder and the image sensing chip are underfilled with stabilizer to form an airtight condition between the PCB, the holder and the image sensing chip.

9. The image sensor module as claimed in claim 8, wherein the all the leads of the PCB are formed on one side of the PCB.

10. The image sensor module as claimed in claim 9, wherein the PCB comprises a module circuit formed thereon for electrically connected to the image sensing chip and multiple connecting lead formed on one side of the PCB for electrically connected to a suitable electric device.

11. The image sensor module as claimed in claim 9, wherein the outer leads are electrically connected to a SMT board by SMT, the SMT board including a module circuit formed thereon, an opening defined therein and multiple connecting leads formed one side of the SMT board, the SMT board including multiple leads formed thereon around the opening and electrically connected to the PCB when the lens set secured on the SMT board and extends through the window.

12. The image sensor module as claimed in claim 8, wherein the inner leads are formed on a first side of the PCB and the outer leads are formed of the a second side of the PCB, each inner lead electrically connected to a corresponding one of the outer leads.

13. The image sensor module as claimed in claim 12, wherein the PCB comprises a module circuit formed thereon and multiple connecting lead formed on one side of the PCB.

14. The image sensor module as claimed in claim 13, wherein the holder includes a bottom abutting the PCB and surround the window in the PCB.

15. The image sensor module as claimed in claim 13, wherein holder includes a recess defined in the bottom of the holder, and the PCB is securely received in the recess in the holder and abutting the bottom of the holder.

16. The image sensor module as claimed in claim 13, wherein the holder comprises an annular defined in an outer periphery of the bottom of the holder for receiving the periphery of the window in the PCB.

17. The image sensor module as claimed in claim 12, wherein the outer leads are electrically connected to a SMT board by SMT, the SMT board including a module circuit formed thereon, an opening defined therein and multiple connecting leads formed one side of the SMT board, the SMT board including multiple leads formed thereon around the opening and electrically connected to the PCB when the lens set secured on the SMT board and extends through the window.

18. The image sensor module as claimed in claim 17, wherein the holder includes a bottom abutting the PCB and surround the window in the PCB.

19. The image sensor module as claimed in claim 17, wherein holder includes a recess defined in the bottom of the holder, and the PCB is securely received in the recess in the holder and abutting the bottom of the holder.

20. The image sensor module as claimed in claim 17, wherein the holder comprises an annular defined in an outer periphery of the bottom of the holder for receiving the periphery of the window in the PCB.

21. An image sensor module comprising:
a printed circuit board (PCB) including a window defined therein and extending through the PCB, a first recess in defined in a lower side of the PCB and communicating with the window, the window and the recess each having an inner periphery that are coated with a shelter, the PCB including multiple leads formed on the lower side around the recess, each lead divided into an inner lead and an outer lead;
an image sensing chip received in the first recess in the PCB, the image sensing chip having multiple solder pads formed thereon, each solder pad electrically connected to a corresponding one of the inner leads; and
a lens set mounted on the PCB and corresponding to the window in the PCB, wherein the peripheries between the lens set, the PCB and the image sensing chip are underfilled with stabilizer to form an airtight condition between the lens set, the PCB and the image sensing chip.

22. The image sensor module as claimed in claim 21, wherein the PCB further comprises a second recess defined in an upper side of the PCB and communicating with the window in the PCB, the bottom of the lens set received in the second recess in the PCB.

23. The image sensor module as claimed in claim 22, wherein the PCB includes a module circuit formed thereon and multiple connecting leads formed on one side of the PCB, the module circuit electrically connected to the image sensing chip and the multiple connecting leads electrically connected to the module circuit.

24. The image sensor module as claimed in claim 22, wherein the outer leads are electrically connected to a SMT board by SMT, the SMT board including a module circuit formed thereon, an opening defined therein and multiple connecting leads formed one side of the SMT board, the SMT board including multiple leads formed thereon around the opening and electrically connected to the PCB when the lens set secured on the SMT board and extends through the window.
